(19) United States
(12) Patent Application Publication
(10) Pub. No.: US 2012/0292804 A1
(43) Pub. Date: Nov. 22, 2012

(54) Apparatus and methods for forming polymeric devices

(76) Inventors: Bruce L. Carvalho, Watertown, MA (US); Maury D. Cosman, Medfield, MA (US)

(21) Appl. No.: 13/506,101

(22) Filed: Mar. 26, 2012

Related U.S. Application Data
(60) Provisional application No. 61/465,905, filed on Mar. 25, 2011.

(51) Int. Cl. B29C 59/02

(52) U.S. Cl. 264/102; 425/385

(57) ABSTRACT

This invention relates to an apparatus and methods for forming polymeric devices, especially fluidic or microfluidic devices used as conduits for controlling fluid flow. Such devices have important applications in chemistry and biology including immunoassays, enzyme assays and cell separation processes. The invention claims the use of fixed-temperature heating of thermoplastic resin in combination with vacuum and low pressure on the tool in order to rapidly produce good quality devices. The combination of features claimed in the invention is important because it enables simple, lightweight, economical equipment to be constructed to fabricate useful polymeric devices.

### REFERENCE TO RELATED APPLICATION

This application claims the benefit of priority to U.S. provisional patent application Ser. No. 61/465,905, filed Mar. 25, 2011, the entire disclosure of which is explicitly incorporated by reference herein.

### FIELD

This invention relates to an apparatus and methods for forming polymeric devices, especially fluidic devices used as conduits for controlling fluid flow.

### BACKGROUND

Polymeric resins are used to produce a variety of manufactured articles and devices. Particularly useful in this regard are thermoplastic resins, which can be readily molded into almost any shape and comprise almost any moldable feature by the application of sufficient heat and pressure to melt the resin. In the practice of making articles and devices using thermoplastic resins, a mold is used. In some cases, the mold is made from a metallic substrate or by photolithography on a glass or silicon base. In other cases, the mold is an elastomeric tool made from a silicone rubber that has been cast against a master part, intended for replication.

Particularly useful devices that can be made from thermoplastic and other polymeric resins are fluidics devices. The use of fluidic devices, particularly microfluidic devices, for chemical or biological assays and syntheses has increased rapidly over the last decade. Examples of the uses to which such devices have been put include immunoassays, enzyme assays, protein crystallization, cell separation, and nucleic acid amplification. While the particular requirements are as broad as the class of assays and syntheses itself, most fluidic devices including microfluidic devices share a few common functions: one or a plurality of fluids, particularly in microliter quantities, are introduced onto the device and the fluids are distributed and metered to defined sites within the device where an assay or synthesis occurs. For microfluidics devices, typically these devices may be as small as a postage stamp or as large as a compact disc. On a given microfluidics device may be found tens to hundreds of input ports, channels, incubation, reaction or detection chambers and, at times, exit ports connected and arrayed in an application-specific microfluidic network. Typically, channels on such microfluidic devices have cross-sectional dimensions ranging from several microns to hundreds of microns, whereas the various ports and chambers that serve as connecting nodes for the microfluidic network are often sized to accommodate fluid volumes ranging from a few to hundreds of microliters. In some instances, surfaces within the microfluidic network are textured with submicron size posts or divots or other features that may be used as diffractive elements or, when functionalized with the appropriate chemistry, as affinity columns for select molecular or cellular species.

As such devices have become more prevalent, polymeric resins have been more frequently used for fabricating such devices instead of glass or silicon. The advantages of using polymeric resins, particularly thermoplastic embodiments thereof, include reduced cost, adequate chemical compatibility and optical properties. When polymeric resins are used, embossing and molding are the preferred methods for forming the devices and the microfluidic components thereof. Using either method, resin is brought in contact with a substrate or tool comprising a negative replica of the structures, such as fluidics structures or microfluidics structures, desired on the device. The application of an appropriate amount of pressure at a sufficient temperature (i.e., higher than the melting, or glass transition temperature, of the thermoplastic resin) and for an adequate amount of time produce the device.

The prior art describes embossing apparatus with means for heating polymeric resins, forcing a tool against the resin with a sufficient amount of pressure to form the resin against the tool, cooling the formed resin and the tool under applied pressure, releasing the pressure from the formed resin and tool and then separating the formed resin from the tool. These apparatus require high forces to push the flowing polymer throughout the tool and means for actively cooling the tools before the pressure is released. These requirements, in turn, add to the size of an embossing apparatus and also add to the number of components used for fabrication, and both contributions typically lead to increased costs to fabricate an embosser.

Thus, there is a need for improved apparatus and methods for forming polymeric devices.

### SUMMARY

Apparatus and methods for forming polymeric devices are disclosed herein. The objective of this invention is an apparatus and method for performing fixed-temperature, vacuum-embossing of microstructured, thermoplastic parts. A typical sequence of process steps include:

setting the process temperature;

placing an embossing tool and thermoplastic resin between the embossing platens;

evacuating the embossing chamber;

closing the platens with a defined force;

embossing the blank with the tool for a pre-determined amount of time;

removing the tool and resin assembly from the instrument;

allowing the assembly to cool below the glass transition of the embossed part on the bench in an ambient environment;

and separating the embossing tool from the embossed part.

We have found that, in combination with vacuum, a fixed-temperature embossing process can produce parts with features suitable for microfluidic devices.

The disclosed apparatus offers the following advantages over existing equipment for embossing of thermoplastic parts:

Operating the heaters at a constant temperature, rather than cycling from the forming temperature to ambient or to an intermediate temperature, allows parts to be formed in less time. This mode of operation is facilitated by the use of a holder for the tool and part that allows removal from the apparatus at the molding temperature. The constant temperature operation avoids the need for a cooling subsystem, simplifying the machine and reducing cost.

The use of vacuum during the molding operation is important in reducing the amount of trapped air in the tool. The air inside features or pockets in the tool must be compressed to reduce its volume and the related size of unfilled regions or defects in the formed part. In the mode of operation mentioned in advantage [0019] in which the tool and part are removed at elevated temperature, if vacuum is not used, the trapped air would expand back to its original volume before the plastic cools below its glass transition temperature, with the potential to cause significant defects.

The application of vacuum during the molding operation, in addition to improving the results for constant temperature operation, provides the benefit of reducing the amount of force required to be applied to the tool and part in order to move plastic through the mold. The lower force levels allow parts to be formed more accurately with less deflection of the soft tools. The lower forces also allow the embossing machine to be constructed with lighter and less-costly components than are needed in other machines.

### BRIEF DESCRIPTION OF THE FIGURES

Further description of the invention, summarized above, can be found in the embodiments illustrated in the appended figures. It is to be noted, however, that the appended figures are only provided as illustrative embodiments of this invention and are therefore not to be considered limiting of its scope, for the invention may admit to other equally effective embodiments.

FIG. 1 schematically a cross-sectional view of an embossing apparatus.

FIGS. 2A-B show a spike and channel embossed in a thermoplastic blank.

FIGS. 3A-B shows posts embossed in a thermoplastic film.

FIG. 4 shows channels and reservoirs embossed from in a thermoplastic blank.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention include apparatus and methods for forming polymeric devices. The inventive apparatus provides fixed-temperature, vacuum embossing with sufficient force and temperature to replicate hard and even soft or elastomeric tools to form thermoplastic devices with microscale features, macroscale features alone or in combination.

Microscale features means raised (or depressed) features with in-plane dimensions from a few microns to hundreds of microns and heights (or depths) of a few microns to hundreds of microns and height to width ratios from less than one to over ten. Macroscale features means raised (or depressed) features with in-plane dimensions from a few millimeters to several centimeters and heights (or depths) of a few millimeters to several centimeters.

The formed features may also be through-holes. Through-holes may be fabricated by forming thermoplastic resin between two patterned tools each with raised features that also make contact when the tools are pressed together and against the interior thermoplastic resin.

The use of two tools each patterned with the same or different patterns can be used to form microscale and macroscale features on the opposing sides of a polymeric device along with through-holes to allow fluidic communication between the features of each side of the device.

While typical polymeric devices are planar, the present invention also provides the capability to form non-planar or curved devices with microscale, macroscale and through-hole features.

The polymeric devices may be formed from a variety of thermoplastic materials. Injection moldable thermoplastics including cyclic olefin copolymers, acrylics, polypropylenes and polycarbonates are preferred resins although other thermoplastics with sufficiently high melt flow index at temperatures in the range 100° C. to 250° C. may also be used with the apparatus and methods of this invention. Extruded thermoplastic films that can flow at elevated temperature may be placed against one tool or between two tools to allow thermoforming of microscale and macroscale features on one or both sides of the film and through-holes to provide communication between these features.

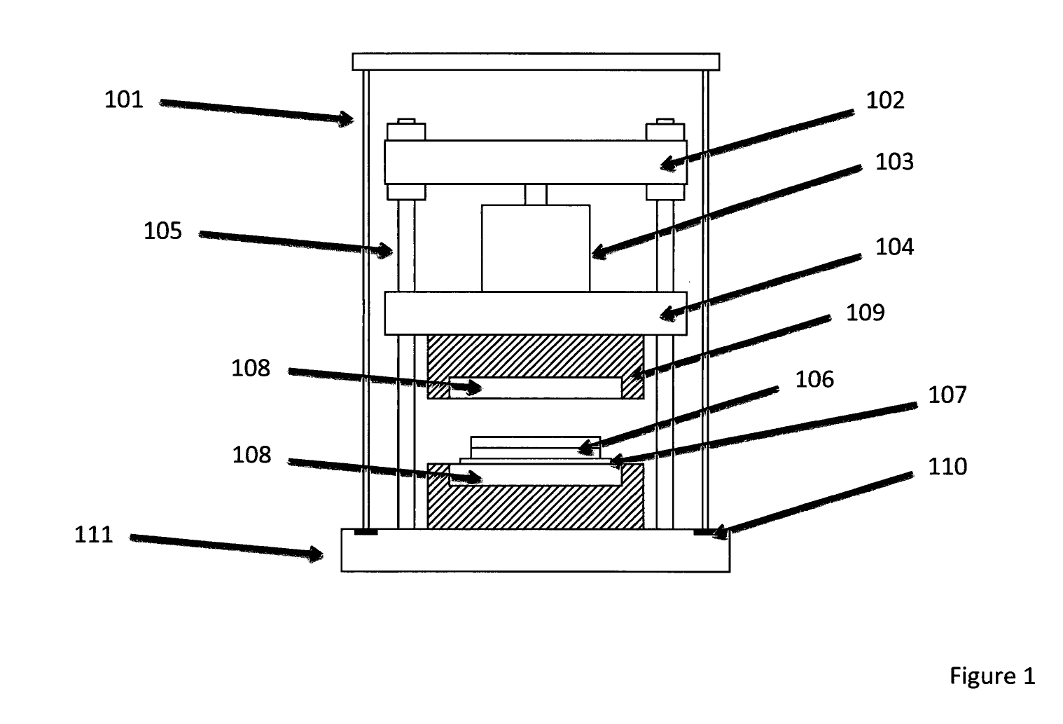

FIG. 1 illustratively depicts a cross-sectional view of an embodiment of the embossing apparatus of this invention. Key components of this embodiment include a vacuum cover 101, an upper frame 102, an air cylinder 103, an upper heater assembly moveable support 104, guide posts 105, a set of upper and lower tools 106, a tool support tray 107, heated plates 108, thermal insulation 109, a vacuum gasket 110 and a base 111.

Not shown but important for the operation of this embodiment is the presence of thermoplastic resin between the upper and lower tools 106. This resin may take the form of resin beads, a preformed (previously compression molded or injection molded) shape or an extruded film.

In a preferred embodiment, the heated plates 108 are aluminum, copper or other thermally conductive material and are heated with cartridge heaters embedded within the plate bodies or blanket heaters attached to the plate surfaces distal to the embossing surfaces. Not shown but useful for the operation of this embodiment are temperature sensors in the upper and lower heated plates that, in combination with a temperature controller, provide closed-loop control of the process temperature on the upper and lower embossing surfaces. The thermal insulation maintains some of the heat within the heated plates, thereby lowering the power dissipation to the moveable support, guide posts, vacuum cover and other components of the apparatus.

In a preferred embodiment, the air cylinder 103 forces the upper heated plate against the upper tool, resin and lower tool assembly, forcing them against the lower heated plate. In a preferred embodiment, electrical and pneumatic connections are made through sealed through-holes in the base of the apparatus and electrical and pneumatic power sources and control modules external to the apparatus.

Certain preferred embodiments of the apparatus and methods of the invention are described in greater detail in the following sections of this application and in the figures.

### EXAMPLE 1

This example describes the fabrication of pre-forms or blanks from thermoplastic resin beads.

Approximately 2 g of cyclic olefin copolymer resin beads (COC 8007 X10 from Topas) was added to a 30 mm diameter, 3 mm deep blind hole in a silicone rubber tool and a 3 mm thick silicone rubber sheet was placed on top of the resin-filled hole to make a resin/tool assembly. The embossing apparatus was heated to 195° C., the resin/tool assembly was placed between the heated plates, the vacuum was engaged to reach a level of 20 inches of mercury and after 7 minutes of equilibration, the plates were forced together. The pressure on the 30 mm diameter section of resin beads was approximately 0.3 N/mm². After 20 minutes of applied pressure and heat, the vacuum and pressure were released, and the resin/tool assembly was removed from the apparatus and left to cool on the bench. After 7 minutes of passive cooling, the formed thermoplastic disk was removed from the rubber tool.

The disk was observed to be free of voids.

### EXAMPLE 2

This example describes the embossing of a spike and channel from a thermoplastic blank.

A pre-formed thermoplastic blank of cyclic olefin copolymer (COC 8007 X10 from Topas) with diameter approximately 30 mm was placed on a silicone rubber sheet. A patterned elastomeric tool was made from a two-part silicone (Mold Max 60 from Smooth-On) by casting and curing the rubber against a part that contained a spike and a microfluidic channel. The patterned elastomeric tool was placed on top of the pre-formed thermoplastic blank, and this assembly was placed on a tray, which was then inserted into the embossing apparatus.

The embossing apparatus was heated to 195° C., the assembly was placed between the heated plates, the vacuum was engaged to reach a level of 20 inches of mercury and after 7 minutes of equilibration, the plates were forced together. The pressure on the 30 mm diameter pre-formed thermoplastic blank was approximately 0.15 N/mm² (21.8 lbs/in²). After 2 minutes of applied pressure and heat, the vacuum and pressure were released, and the assembly was removed from the apparatus and left to cool on the bench. After 7 minutes of passive cooling, the patterned elastomeric tool was separated from the now formed or patterned thermoplastic part.

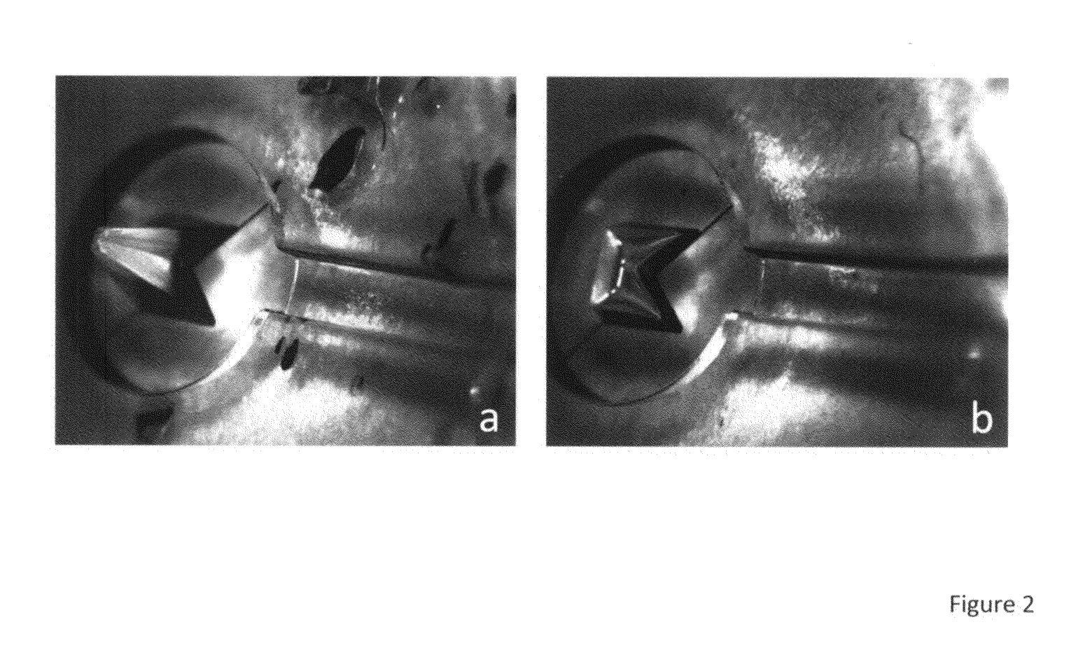

FIG. 2(a) is an oblique optical micrograph showing a section of the part that was formed during this fixed-temperature, vacuum embossing process. The part includes a well-defined spike and microfluidic channel. To establish a scale for this figure, note that the measured width of the microfluidic channel is approximately 0.8 mm. The voids seen in FIG. 2(a) were present in the pre-formed blank and were not a result of the process for embossing the spike and channel.

In order to understand the effect of vacuum on the embossed features, the above process was repeated without vacuum (at ambient pressure).

FIG. 2(b) is an oblique optical micrograph showing a section of the formed part. The part includes a poorly-defined spike and microfluidic channel. To establish a scale for this figure, note that the measured width of the microfluidic channel is approximately 0.8 mm.

This example shows the advantages of using vacuum with this embossing process.

### EXAMPLE 3

This example describes the embossing of a microposts from a thermoplastic film.

An extruded film of cyclic olefin copolymer (COC 9506 from Topas) with with length, width and thickness approximately 75 mm, 25 mm and 0.04 mm, respectively, was placed on patterned elastomeric tool. The tool was made from a two-part silicone ((Shin Etsu KE-1600 and CX-832) by casting and curing the rubber against an etched silicon part with microscale posts. The post diameters and heights are approximately 100 microns. A non-patterned elastomeric tool was then placed on top of the extruded film, and this assembly was placed on a tray, which was then inserted into the embossing apparatus.

The embossing apparatus was heated to 195° C., the assembly was placed between the heated plates, the vacuum was engaged to reach a level of 20 inches of mercury and after 7 minutes of equilibration, the plates were forced together. The pressure on the 30 mm diameter pre-formed thermoplastic blank was approximately 0.15 N/mm². After 2 minutes of applied pressure and heat, the vacuum and pressure were released, and the assembly was removed from the apparatus and left to cool on the bench. After 7 minutes of passive cooling, the patterned elastomeric tool was separated from the now formed or patterned thermoplastic part.

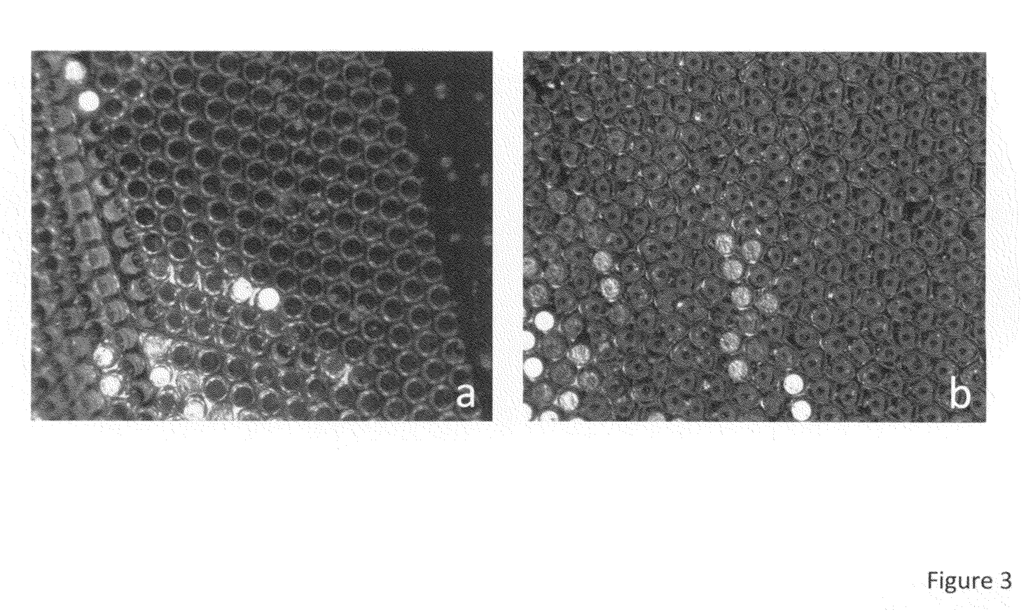

FIG. 3(a) is an oblique optical micrograph showing a section of the part that was formed during this fixed-temperature, vacuum embossing process. The part includes a well-defined microposts. To establish a scale for this figure, note that the approximate diameter of an individual post is 100 microns.

In order to understand the effect of vacuum on the embossed features, the above process was repeated without vacuum (at ambient pressure).

FIG. 3(b) is an oblique optical micrograph showing a section of the formed part. The part includes a majority of poorly-defined microposts with a smaller number of better-defined microposts. To establish a scale for this figure, note that the approximate diameter of an individual post is 100 microns.

This example shows the advantages of using vacuum with this embossing process.

### EXAMPLE 4

This example describes the embossing of a polymeric device with channels and reservoirs from a pre-formed thermoplastic blank.

A pre-formed thermoplastic blank of cyclic olefin copolymer (COC 8007 X10 from Topas) with length, width and thickness approximately 75 mm, 25 mm and 1 mm, respectively, was placed on a silicone rubber sheet. A patterned elastomeric tool was made from a two-part silicone (Shin Etsu KE-1600 and CX-832) by casting and curing the rubber against a machined part with microfluidic channels and reservoirs. The patterned elastomeric tool was placed on top of the pre-formed thermoplastic blank, and this assembly was placed on a tray, which was then inserted into the embossing apparatus.

The embossing apparatus was heated to 195° C., the assembly was placed between the heated plates, the vacuum was engaged to reach a level of 20 inches of mercury and after 7 minutes of equilibration, the plates were forced together. The pressure on the 75 mm by 25 mm pre-formed thermoplastic blank was approximately 0.15 N/mm². After 10 minutes of applied pressure and heat, the vacuum and pressure were released, and the assembly was removed from the apparatus and left to cool on the bench. After 7 minutes of passive cooling, the patterned elastomeric tool was separated from the formed thermoplastic part.

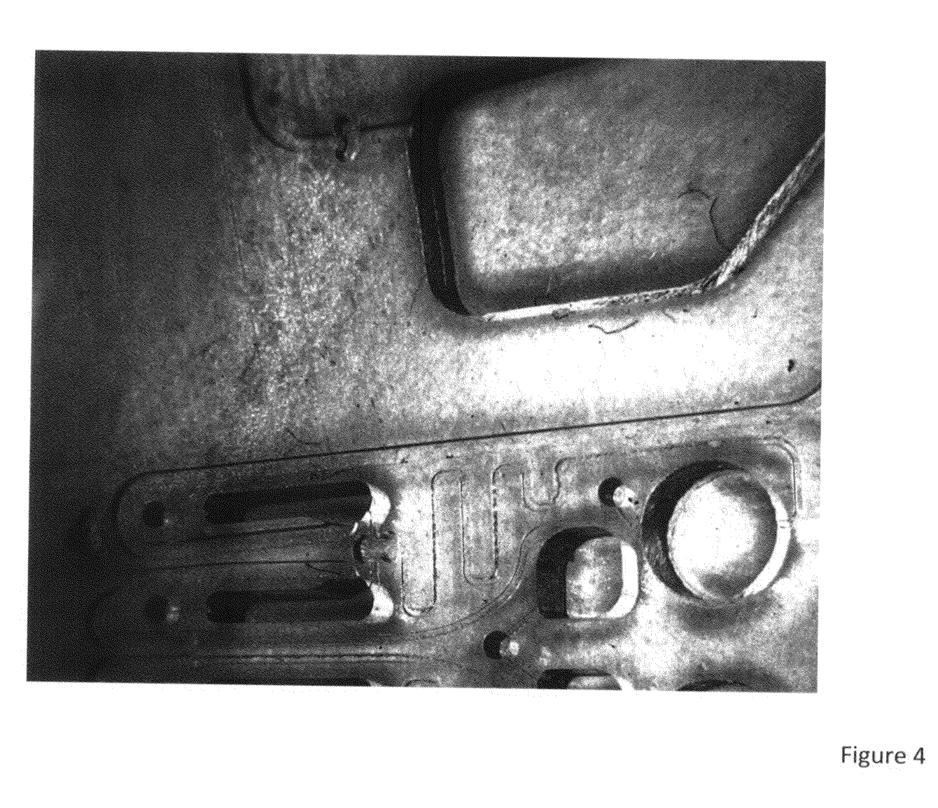

FIG. 4 is an oblique optical micrograph showing a section of the formed part. The part includes well-defined fluidic channels and reservoirs. To establish a scale for this figure, note that the measured width of the reservoir at the top right of the micrograph is approximately 3.6 mm and the measured width of the largest channel is approximately 250 microns.

What is claimed is:

1. An apparatus for forming thermoplastic parts at low forces using patterned tools and combined application of heat and vacuum.

2. The apparatus of claim 1 to include a removable tray or holder to allow the forming tools and work-piece to be removed without requiring the cooling of the heated processing zone.

3. The apparatus of claim 1 in which the forming tools are elastomeric and flexible and are patterned with raised, depressed, microscale and macroscale features.

4. The apparatus of claim 1 in which the heat is applied at temperatures in the range from 100° C. to 250° C.

5. The apparatus of claim 1 in which the vacuum level is held in the range between 20 inches of mercury to 29.92 inches of mercury.

6. The apparatus of claim 1 in which the pressures applied on the tool or tools and thermoplastic resin are in the range from 1 lb/in² to 100 lb/in².

7. The apparatus of claim 1 in which the heat is applied by aluminum or copper or other thermally-conductive plates containing embedded electric cartridge heaters.

8. The apparatus of claim 1 in which the heat is applied by aluminum, copper or other thermally-conductive plates incorporating blanket heaters.

9. The apparatus of claim 1 in which the force is applied to the heated plates and tooling by a pneumatic cylinder.

10. The apparatus of claim 1 in which the force is applied to the heated plates and tooling by a motor driving a lead screw, ball screw, worm gear or other mechanical drive train.

11. The apparatus of claim 1 in which the force is applied to the heated plates and tooling by a hydraulic cylinder.

12. A method of forming polymeric devices with microscale or macroscale features individually or in combination wherein the method comprises the steps of:
a. setting the process temperature;
b. placing an embossing tool and thermoplastic resin between the heated plates;
c. evacuating the embossing chamber;
d. closing the plates with a defined force;
e. embossing the resin with the tool for a pre-determined amount of time;
f. removing the tool and resin assembly from the apparatus;
g. allowing the assembly to cool below the glass transition of the embossed part on the bench in an ambient environment;
h. and separating the embossing tool from the embossed part.

13. The method of claim 12 where the thermoplastic resin consists of resin beads or pre-formed blanks or extruded film.
